(19) United States
(12) Patent Application Publication
(10) Pub. No.: US 2020/0107300 A1
(43) Pub. Date: Apr. 2, 2020

(54) METHOD FOR TRANSMITTING OR RECEIVING DATA IN WIRELESS COMMUNICATION SYSTEM, AND DEVICE THEREFOR

(71) Applicant: LG ELECTRONICS INC., Seoul (KR)

(72) Inventors: Kyuhwan KWAK, Seoul (KR); Hyunho LEE, Seoul (KR); Yunjung YI, Seoul (KR); Inkwon SEO, Seoul (KR); Daesung HWANG, Seoul (KR); Seungmin LEE, Seoul (KR)

(73) Assignee: LG ELECTRONICS INC., Seoul (KR)

(21) Appl. No.: 16/496,945

(22) PCT Filed: Mar. 23, 2018
(86) PCT No.: PCT/KR2018/003457

§ 371 Date: Sep. 23, 2019

Related U.S. Application Data
(60) Provisional application No. 62/475,855, filed on Mar. 23, 2017.
(60) Provisional application No. 62/476,049, filed on Mar. 24, 2017.
(60) Provisional application No. 62/501,723, filed on May 4, 2017.
(60) Provisional application No. 62/521,317, filed on Jun. 16, 2017.
(60) Provisional application No. 62/533,592, filed on Jul. 17, 2017.

(51) Int. Cl. H04W 72/04; H04W 72/00

(52) U.S. Cl. CPC H04W 72/042; H04W 72/0446; H04W 72/005

(57) ABSTRACT

Disclosed are a method for transmitting and receiving data in a wireless communication system and an apparatus therefor. A method for configuring, by a terminal, a resource of a control channel in a wireless communication system supporting a short transmission time unit may include: receiving, from a base station, first resource allocation information for allocating multiple resource sets configured for transmission of a downlink control channel; receiving, from the base station, second resource allocation information indicating whether at least one specific resource set which belongs to the multiple resource sets is usable for transmission of a downlink data channel; and receiving, from the base station, the downlink data channel through the at least one specific resource set when the at least one specific resource set is usable for the transmission of the downlink data channel.

### TECHNICAL FIELD

The present invention relates to a wireless communication system, and more particularly, to a method for transmitting and receiving data in a wireless communication system supporting a short transmission time unit and an apparatus supporting the same.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for a high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive Multiple Input Multiple Output (MIMO), in-band full duplex, non-orthogonal multiple access (NOMA), supporting super-wide band, and device networking, have been researched.

### DISCLOSURE

### Technical Problem

This specification proposes a method for transmitting and receiving data in a wireless communication system.

Specifically, this specification proposes a method for transmitting and receiving data by considering a short transmission time interval.

In this regard, this specification proposes a method for transmitting information in a time division multiplexing structure between different channels.

Further, this specification proposes a method for configuring a control channel by considering a short transmission time unit.

Further, this specification proposes a method for applying interleaver by considering a resource element group.

Further, this specification proposes a method for configuring a resource set for transmitting control information.

Further, this specification proposes a method for configuring a search space for downlink control information configured considering a short transmission time unit.

Further, this specification proposes a method for performing multiplexing and channel state information reporting in a system supporting a short transmission time unit.

The technical objects to attain in the present invention are not limited to the above-described technical objects and other technical objects which are not described herein will become apparent to those skilled in the art from the following description.

### Technical Solution

In an aspect of the present invention, a method for configuring, by a terminal, a resource of a control channel in a wireless communication system supporting a short transmission time unit may include: receiving, from a base station, first resource allocation information for allocating multiple resource sets configured for transmission of a downlink control channel; receiving, from the base station, second resource allocation information indicating whether at least one specific resource set which belongs to the multiple resource sets is usable for transmission of a downlink data channel; and receiving, from the base station, the downlink data channel through the at least one specific resource set when the at least one specific resource set is usable for the transmission of the downlink data channel.

Furthermore, according to the embodiment of the present invention, in the method, the at least one specific resource set may include at least one reserved resource set, and when the at least one reserved resource set is activated, the at least one reserved resource set may not be used for the transmission of the downlink data channel.

Furthermore, according to the embodiment of the present invention, in the method, the first resource allocation information may include information indicating at least one of a mapping structure, a transmission scheme, or a type of reference signal for each of the multiple resource sets.

Furthermore, according to the embodiment of the present invention, in the method, the downlink control channel and the downlink data channel may be configured according to a transmission time unit set to a smaller number than 14 OFDM symbols.

Furthermore, according to the embodiment of the present invention, in the method, the first resource allocation information and the second resource allocation information may be transmitted through higher layer signaling.

Furthermore, according to the embodiment of the present invention, in the method, the first resource allocation information may be transmitted through the higher layer signaling, and the second resource allocation information may be transmitted through downlink control information.

Furthermore, according to the embodiment of the present invention, in the method, when the at least one specific resource set is allocated to a Multicast-Broadcast Single Frequency Network (MBSFN) subframe, the transmission of the downlink control channel or the transmission of the downlink data channel may be based on a Demodulation Reference Signal (DMRS).

Furthermore, according to the embodiment of the present invention, in the method, the first resource allocation information may include information indicating the number of blind decoding times for each of the multiple resource sets.

In another aspect of the present invention, a terminal configuring a resource of a control channel in a wireless communication system supporting a short transmission time unit may include: a Radio Frequency (RF) unit for transmitting and receiving a radio signal; and a processor functionally connected to the RF unit, in which the processor may be configured to receive, from a base station, first resource allocation information for allocating multiple resource sets configured for transmission of a downlink control channel, receive, from the base station, second resource allocation information indicating whether at least one specific resource set which belongs to the multiple resource sets is usable for transmission of a downlink data channel, and receive, from the base station, the downlink data channel through the at least one specific resource set when the at least one specific resource set is usable for the transmission of the downlink data channel.

In yet another aspect of the present invention, a method for configuring, by a base station, a resource of a control channel in a wireless communication system supporting a short transmission time unit may include: transmitting, to a terminal, first resource allocation information for allocating multiple resource sets configured for transmission of a downlink control channel; transmitting, to the terminal, second resource allocation information indicating whether at least one specific resource set which belongs to the multiple resource sets is usable for transmission of a downlink data channel; and transmitting, from the terminal, the downlink data channel through the at least one specific resource set when the at least one specific resource set is usable for the transmission of the downlink data channel.

### Advantageous Effects

According to an embodiment of the present invention, even when a short transmission time unit coexists with a legacy transmission time unit, by setting an optimal resource allocation unit, resources can be efficiently scheduled and latency can be minimized.

Effects which may be obtained by the present invention are not limited to the aforementioned effects, and other technical effects not described above may be evidently understood by a person having ordinary skill in the art to which the present invention pertains from the following description.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 illustrates the structure of a radio frame in a wireless communication system to which the present invention may be applied.

FIG. 2 is a diagram illustrating a resource grid for one downlink slot in a wireless communication system to which the present invention may be applied.

FIG. 3 illustrates the structure of a downlink subframe in a wireless communication system to which the present invention may be applied.

FIG. 4 illustrates the structure of an uplink subframe in a wireless communication system to which the present invention may be applied.

FIG. 5 illustrates an example of a short transmission time interval (TTI) based radio frame structure to which a method proposed by this specification may be applied.

FIG. 6 illustrates an example of a resource grid supported by an NR system to which a method proposed by this specification may be applied.

FIG. 7 illustrates an example of a radio frame structure in an NR system to which a method proposed by this specification may be applied.

FIG. 8 illustrates an example of a method for transmitting a Demodulation Reference Signal (DMRS) in an sTTI structure to which a method proposed by this specification may be applied.

FIG. 9 illustrates an example of a method for performing rate matching for a control channel region to which a method proposed by this specification may be applied.

FIG. 10 illustrates an example of an REG configuration to which a method proposed by this specification may be applied.

FIG. 11 illustrates another example of an REG configuration to which a method proposed by this specification may be applied.

FIG. 12 illustrates yet another example of an REG configuration to which a method proposed by this specification may be applied.

FIG. 13 illustrates an example of an resource grid to which a DMRS for an sTTI is applied to which a method proposed by this specification may be applied.

FIG. 14 illustrates an example of an interleaving scheme to which a method used in a legacy system may be applied.

FIG. 15 illustrates an example of an interleaving scheme to which a method proposed by this specification may be applied.

FIG. 16 illustrates an example of signaling between a base station and a terminal for configuring a resource of a control channel in a wireless communication system supporting a short transmission time unit to which a method proposed by this specification may be applied.

FIG. 17 illustrates a block diagram of a wireless communication device to which methods proposed by this specification may be applied.

FIG. 18 illustrates a block diagram of a communication device according to an embodiment of the present invention.

### MODE FOR INVENTION

Some embodiments of the present invention are described in detail with reference to the accompanying drawings. A detailed description to be disclosed along with the accompanying drawings are intended to describe some exemplary embodiments of the present invention and are not intended to describe a sole embodiment of the present invention. The following detailed description includes more details in order to provide full understanding of the present invention. However, those skilled in the art will understand that the present invention may be implemented without such more details

In some cases, in order to avoid that the concept of the present invention becomes vague, known structures and devices are omitted or may be shown in a block diagram form based on the core functions of each structure and device.

In this specification, a base station (BS) (or eNB) has the meaning of a terminal node of a network over which the base station directly communicates with a device. In this document, a specific operation that is described to be performed by a base station may be performed by an upper node of the base station according to circumstances. That is, it is evident that in a network including a plurality of network nodes including a base station, various operations performed for communication with a device may be performed by the base station or other network nodes other than the base station. The base station (BS) may be substituted with another term, such as a fixed station, a Node B, an eNB (evolved-NodeB), a Base Transceiver System (BTS), an access point (AP) or gNB(general NB, generation NB). Furthermore, the device may be fixed or may have mobility and may be substituted with another term, such as User Equipment (UE), a Mobile Station (MS), a User Terminal (UT), a Mobile Subscriber Station (MSS), a Subscriber Station (SS), an Advanced Mobile Station (AMS), a Wireless Terminal (WT), a Machine-Type Communication (MTC) device, a Machine-to-Machine (M2M) device, or a Device-to-Device (D2D) device, and the like.

Hereinafter, a downlink means communication from the base station to the terminal and an uplink means communication from the terminal to the base station. In the downlink, a transmitter may be a part of the base station and a receiver may be a part of the terminal. In the uplink, the transmitter may be a part of the terminal and the receiver may be a part of the base station.

Specific terms used in the following description are provided to help understanding of the present invention and the use of such specific terms may be modified into other forms within the scope without departing from the technical spirit of the present invention.

The following technologies may be used in various wireless communication systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology universal terrestrial radio access (UTRA) or CDMA2000. TDMA may be implemented by radio technology such as global system for mobile communications (GSM)/general packet radio service(GPRS)/enhanced data rates for GSM Evolution (EDGE). OFDMA may be implemented as radio technology such as IEEE 802.11(Wi-Fi), IEEE 802.16 (WiMAX), IEEE 802-20, E-UTRA (Evolved UTRA), and the like. The UTRA is a part of a universal mobile telecommunication system (UMTS). 3rd generation partnership project (3GPP) long term evolution (LTE) as a part of an evolved UMTS (E-UMTS) using evolved-UMTS terrestrial radio access (E-UTRA) adopts the OFDMA in a downlink and the SC-FDMA in an uplink. LTE-advanced (A) is an evolution of the 3GPP LTE.

Embodiments of the present invention may be based on standard documents disclosed in at least one of IEEE 802, 3GPP, and 3GPP2 which are the wireless access systems. That is, steps or parts which are not described to clearly expose the technical spirit of the present invention may be supported by the documents. Further, all terms disclosed in this document may be described by the standard documents.

In order to more clarify a description, 3GPP LTE/LTE-A/NR(New RAT) is chiefly described, but the technical characteristics of the present invention are not limited thereto.

General System

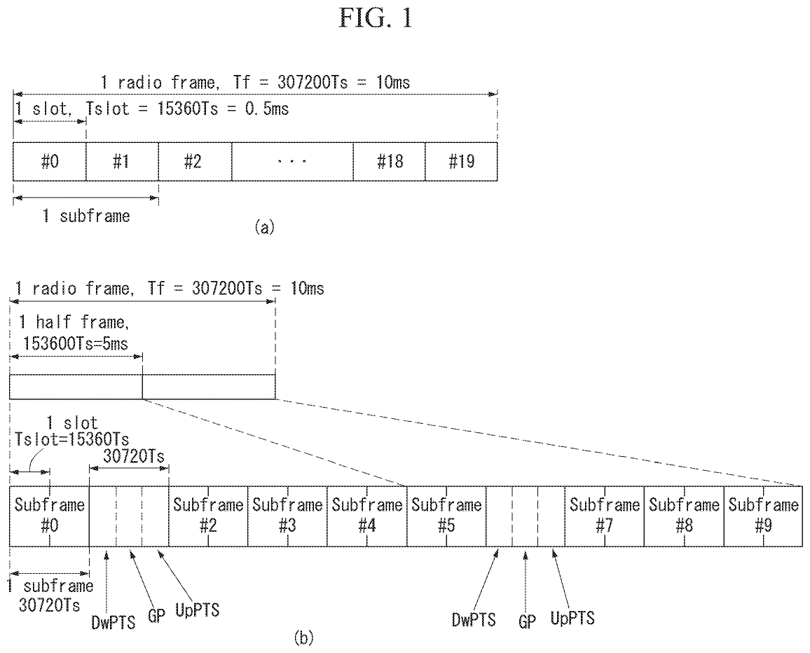

FIG. 1 shows the structure of a radio frame in a wireless communication system to which an embodiment of the present invention may be applied.

3GPP LTE/LTE-A support a radio frame structure type 1 which may be applicable to Frequency Division Duplex (FDD) and a radio frame structure which may be applicable to Time Division Duplex (TDD).

In FIG. 1, the size of the radio frame in the time domain is represented by a multiple of a time unit of T_s=1/(15000*2048). The downlink and uplink transmissions are composed of radio frames having intervals of T_f=307200*T_s=10 ms.

FIG. 1(a) illustrates the radio frame structure type 1. Type 1 radio frames can be applied to both full duplex and half duplex FDD.

A radio frame consists of 10 subframes. One radio frame is composed of 20 slots having a length of T_slot=15360*T_s=0.5 ms, and each slot is given an index from 0 to 19. One subframe is constituted by two consecutive slots in the time domain, and the subframe i is constituted by slots 2i and 2i+1. The time taken to send one subframe is called a Transmission Time Interval (TTI). For example, one subframe may have a length of 1 ms, and one slot may have a length of 0.5 ms.

In the FDD, the uplink transmission and the downlink transmission are classified in the frequency domain. There is no limitation on full-duplex FDD, whereas in half-duplex FDD operation, the UE can not transmit and receive at the same time.

One slot includes a plurality of Orthogonal Frequency Division Multiplexing (OFDM) symbols in the time domain and includes a plurality of Resource Blocks (RBs) in a frequency domain. In 3GPP LTE, OFDM symbols are used to represent one symbol period because OFDMA is used in downlink. An OFDM symbol may be called one SC-FDMA symbol or symbol period. An RB is a resource allocation unit and includes a plurality of contiguous subcarriers in one slot.

FIG. 1(b) illustrates the frame structure type 2. The Type 2 radio frame consists of two half frames each having a length of 153600*T_s=5 ms. Each half frame consists of 5 subframes with a length of 30720*T_s=1 ms.

In the type 2 radio frame structure of a TDD system, an uplink-downlink configuration is a rule showing how uplink and downlink are allocated (or reserved) with respect to all of subframes. Table 1 shows the uplink-downlink configuration.

TABLE 1

| | Downlink- | | | | | | | | | | | |
|---|---|---|---|---|---|---|---|---|---|---|---|---|
| | to-Uplink | | | | | | | | | | | |
| Uplink- | Switch- | | | | | | | | | | | |
| Downlink | point | | Subframe number | | | | | | | | | |
| configuration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

Referring to Table 1, for each sub frame of the radio frame, ‘D’ represents a subframe for downlink transmission, ‘U’ represents a subframe for uplink transmission, and ‘S’ represents a special subframe constituted by three fields such as the DwPTS, the GP, and the UpPTS.

The DwPTS is used for initial cell search, synchronization, or channel estimation in the UE. The UpPTS is used to match the channel estimation at the base station and the uplink transmission synchronization of the UE. GP is a period for eliminating the interference caused in the uplink due to the multipath delay of the downlink signal between the uplink and the downlink.

Each subframe i is composed of a slot 2i and a slot 2i+1 each having a length of T_slot=15360*T_s=0.5 ms.

The uplink-downlink configuration may be divided into seven types. The location and/or number of downlink subframes, special subframes, and uplink subframes are different in the seven types.

A point of time at which a change is performed from downlink to uplink or a point of time at which a change is performed from uplink to downlink is called a switching point. The periodicity of the switching point means a cycle in which an uplink subframe and a downlink subframe are changed is identically repeated. Both 5 ms and 10 ms are supported in the periodicity of a switching point. If the periodicity of a switching point has a cycle of a 5 ms downlink-uplink switching point, the special subframe S is present in each half frame. If the periodicity of a switching point has a cycle of a 5 ms downlink-uplink switching point, the special subframe S is present in the first half frame only.

In all of the seven configurations, No. 0 and No. 5 subframes and DwPTSs are an interval for only downlink transmission. The UpPTSs, the subframes, and a subframe subsequent to the subframes are always an interval for uplink transmission.

Such uplink-downlink configurations may be known to both an eNB and UE as system information. An eNB may notify UE of a change of the uplink-downlink allocation state of a radio frame by transmitting only the index of uplink-downlink configuration information to the UE whenever the uplink-downlink configuration information is changed. Furthermore, configuration information is kind of downlink control information and may be transmitted through a Physical Downlink Control Channel (PDCCH) like other scheduling information. Configuration information may be transmitted to all UEs within a cell through a broadcast channel as broadcasting information.

Table 2 shows a configuration (i.e., the length of a DwPTS/GP/UpPTS) of the special subframe.

TABLE 2

| | Normal cyclic prefix in downlink | | | Extended cyclic prefix in downlink | | |
|---|---|---|---|---|---|---|
| Special | | UpPTS | | | UpPTS | |
| subframe | | Normal cyclic | Extended cyclic | | Normal cyclic | Extended cyclic |
| configuration | DwPTS | prefix in uplink | prefix in uplink | DwPTS | prefix in uplink | prefix in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

The structure of a radio frame according to the example of FIG. 1 is only one example. The number of subcarriers included in one radio frame, the number of slots included in a subframe, and the number of OFDM symbols included in one slot may be changed in various ways.

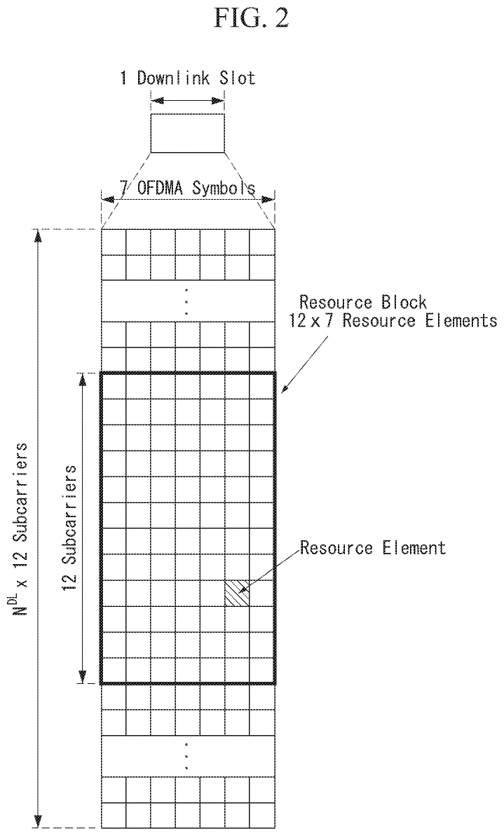

FIG. 2 is a diagram illustrating a resource grid for one downlink slot in a wireless communication system to which the present invention may be applied.

Referring to FIG. 2, one downlink slot includes the plurality of OFDM symbols in a time domain. Herein, it is exemplarily described that one downlink slot includes 7 OFDM symbols and one resource block includes 12 subcarriers in the frequency domain, but the present invention is not limited thereto.

Each element on the resource grid is referred to as a resource element, and one resource block (RB) includes 12×7 resource elements. The number of RBs NADL included in a downlink slot depends on a downlink transmission bandwidth.

A structure of an uplink slot may be the same as that of a downlink slot.

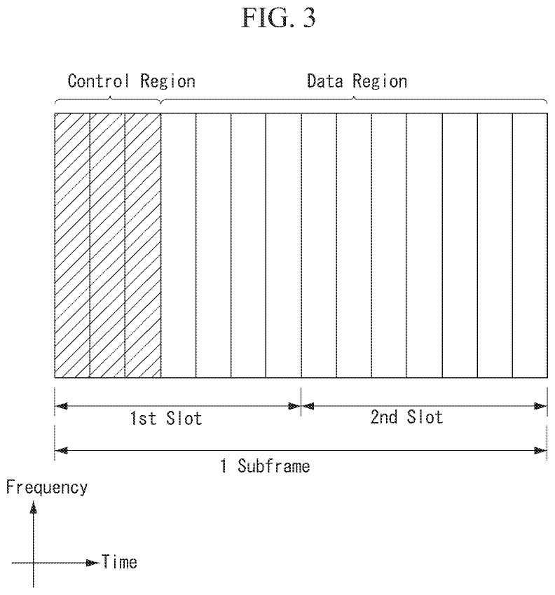

FIG. 3 shows a structure of a downlink subframe in a wireless communication system to which an embodiment of the present invention may be applied.

Referring to FIG. 3, a maximum of three OFDM symbols located in a front portion of a first slot of a subframe correspond to a control region in which control channels are allocated, and the remaining OFDM symbols correspond to a data region in which a physical downlink shared channel (PDSCH) is allocated. Downlink control channels used in 3GPP LTE include, for example, a physical control format indicator channel (PCFICH), a physical downlink control channel (PDCCH), and a physical hybrid-ARQ indicator channel (PHICH), and the like.

A PCFICH is transmitted in the first OFDM symbol of a subframe and carries information about the number of OFDM symbols (i.e., the size of a control region) which is used to transmit control channels within the subframe. A PHICH is a response channel for uplink and carries an acknowledgement (ACK)/not-acknowledgement (NACK) signal for a Hybrid Automatic Repeat Request (HARQ). Control information transmitted in a PDCCH is called Downlink Control Information (DCI). DCI includes uplink resource allocation information, downlink resource allocation information, or an uplink transmission (Tx) power control command for a specific UE group.

A PDCCH may carry information about the resource allocation and transport format of a downlink shared channel (DL-SCH) (this is also called an “downlink grant”), resource allocation information about an uplink shared channel (UL-SCH) (this is also called a “uplink grant”), paging information on a PCH, system information on a DL-SCH, the resource allocation of a higher layer control message, such as a random access response transmitted on a PDSCH, a set of transmission power control commands for individual UE within specific UE group, and the activation of a Voice over Internet Protocol (VoIP), etc. A plurality of PDCCHs may be transmitted within the control region, and UE may monitor a plurality of PDCCHs. A PDCCH is transmitted on a single Control Channel Element (CCE) or an aggregation of some contiguous CCEs. A CCE is a logical allocation unit that is used to provide a PDCCH with a coding rate according to the state of a radio channel. A CCE corresponds to a plurality of resource element groups. The format of a PDCCH and the number of available bits of a PDCCH are determined by an association relationship between the number of CCEs and a coding rate provided by CCEs.

A base station determines the format of a PDCCH based on DCI to be transmitted to UE and attaches a Cyclic Redundancy Check (CRC) to control information. A unique identifier (a Radio Network Temporary Identifier (RNTI)) is masked to the CRC depending on the owner or use of a PDCCH. If the PDCCH is a PDCCH for specific UE, an identifier unique to the UE, for example, a Cell-RNTI (C-RNTI) may be masked to the CRC. If the PDCCH is a PDCCH for a paging message, a paging indication identifier, for example, a Paging-RNTI (P-RNTI) may be masked to the CRC. If the PDCCH is a PDCCH for system information, more specifically, a System Information Block (SIB), a system information identifier, for example, a System Information-RNTI (SI-RNTI) may be masked to the CRC. A Random Access-RNTI (RA-RNTI) may be masked to the CRC in order to indicate a random access response which is a response to the transmission of a random access preamble by UE.

Enhanced PDCCH (EPDCCH) carries UE-specific signaling. The EPDCCH is located in a physical resource block (PRB) that is set to be terminal specific. In other words, as described above, the PDCCH can be transmitted in up to three OFDM symbols in the first slot in the subframe, but the EPDCCH can be transmitted in a resource region other than the PDCCH. The time (i.e., symbol) at which the EPDCCH in the subframe starts may be set in the UE through higher layer signaling (e.g., RRC signaling, etc.).

The EPDCCH is a transport format, a resource allocation and HARQ information associated with the DL-SCH and a transport format, a resource allocation and HARQ information associated with the UL-SCH, and resource allocation information associated with SL-SCH (Sidelink Shared Channel) and PSCCH Information, and so on. Multiple EPDCCHs may be supported and the terminal may monitor the set of EPCCHs.

The EPDCCH can be transmitted using one or more successive advanced CCEs (ECCEs), and the number of ECCEs per EPDCCH can be determined for each EPDCCH format.

Each ECCE may be composed of a plurality of enhanced resource element groups (EREGs). EREG is used to define the mapping of ECCE to RE. There are 16 EREGs per PRB pair. All REs are numbered from 0 to 15 in the order in which the frequency increases, except for the RE that carries the DMRS in each PRB pair.

The UE can monitor a plurality of EPDCCHs. For example, one or two EPDCCH sets may be set in one PRB pair in which the terminal monitors the EPDCCH transmission.

Different coding rates can be realized for the EPCCH by merging different numbers of ECCEs. The EPCCH may use localized transmission or distributed transmission, which may result in different mapping of the ECCE to the REs in the PRB.

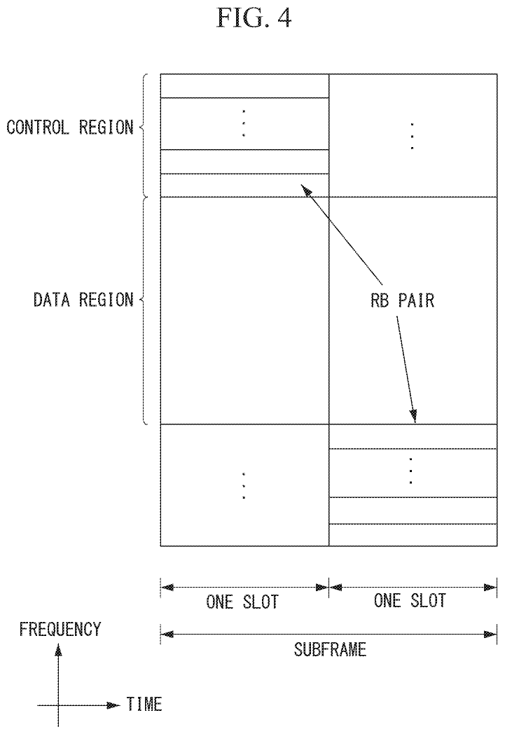

FIG. 4 shows a structure of an uplink subframe in a wireless communication system to which an embodiment of the present invention may be applied.

Referring to FIG. 4, the uplink subframe may be divided into a control region and a data region in a frequency domain. A physical uplink control channel (PUCCH) carrying uplink control information is allocated to the control region. A physical uplink shared channel (PUSCH) carrying user data is allocated to the data region. In order to maintain single carrier characteristic, one UE does not send a PUCCH and a PUSCH at the same time.

A Resource Block (RB) pair is allocated to a PUCCH for one UE within a subframe. RBs belonging to an RB pair occupy different subcarriers in each of 2 slots. This is called that an RB pair allocated to a PUCCH is frequency-hopped in a slot boundary.

Short Transmission Time Interval (sTTI)

In a next-generation communication system, a scheme for achieving a very short latency time when transmitting and receiving information is considered. To this end, a structure of shortening a transmission time interval (TTI) may be considered and in this case, a channel for transmitting and receiving data and control information needs to be newly designed.

A TTI which is configured shorter than the existing TTI (i.e., one subframe (1 ms) may be referred to as the short transmission time interval (sTTI). Hereinafter, in this specification, the sTTI may be appreciated as the same meaning as one short TTI subframe (or short subframe).

As an example, the STTI may be configured by OFDM symbol unit (e.g., 2 symbol sTTI, 3 symbol sTTI, and 7 symbol sTTI) and configured to be aligned on a boundary of the existing TTI.

Control and data channels related to the sTTI may be expressed in a form in which ‘s-’ is added to a channel used in legacy LTE. For example, a physical downlink control channel may be expressed as sPDCCH, a physical downlink data channel may be expressed as sPDSCH, a physical uplink control channel may be expressed as sPUCCH, and a physical uplink data channel may be expressed as sPUSCH.

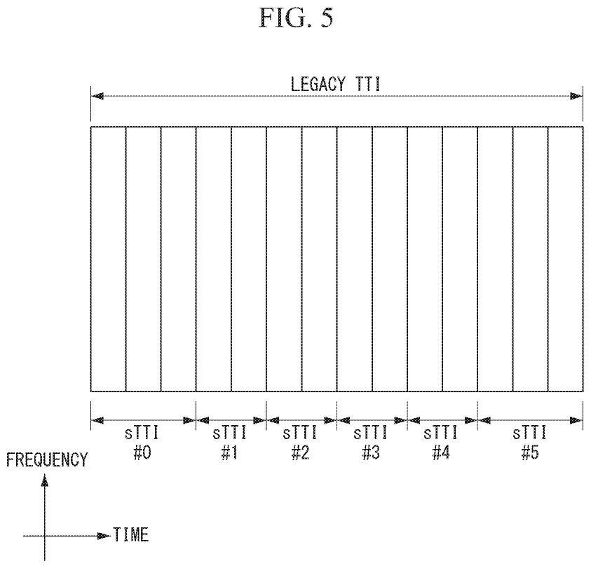

FIG. 5 illustrates an example of a short transmission time interval (TTI) based radio frame structure to which a method proposed by this specification may be applied. FIG. 5 is just for convenience of the description and does not limit the scope of the present invention.

Referring to FIG. 5, six sTTIs (i.e., four 2 symbol STTIs and two 3 symbol STTIs) may be aligned according to the existing legacy TTI (i.e., 14 OFDM symbols). That is, with respect to 14 OFDM symbols, sTTIs may be disposed in a scheme of 3(sTTI #0)-2(sTTI #1)-2(sTTI #2)-2(sTTI #3)-2(sTTI #4)-3(sTTI #5). However, an alignment method of the sTTIs is not limited thereto and may be configured by various combinations using sTTIs constituted by various symbol numbers.

In this case, downlink control information (DCI) for each sTTI may be configured to be forwarded through the short PDCCH (sPDCCH) configured for each sTTI. Alternatively, in the case of some sTTIs (e.g., sTTI disposed at the beginning based on the legacy TTI), the DCI for the corresponding sTTI may be forwarded through not the sPDCCH but the existing PDCCH area (i.e., a maximum of three OFDM symbols before the legacy TTI).

Overview of NR System

As propagation of smart phones and Internet of things (IoT) terminals rapidly spreads, the amount of information which is transmitted and received through a communication network increases. Accordingly, in the next generation wireless access technology, an environment (e.g., enhanced mobile broadband communication) that provides a faster service to more users than existing communication systems (or existing radio access technology) needs to be considered.

To this end, a design of a communication system that considers machine type communication (MTC) providing a service by connecting multiple devices and objects is discussed. Further, a design of a communication system (e.g., Ultra-Reliable and Low Latency Communication (URLLC)) considering a service and/or a user equipment sensitive to reliability and/or latency of communication is also discussed.

Hereinafter, in this specification, for easy description, the next-generation wireless access technology is referred to as a new radio access technology (RAT) (NR) radio access technology and the wireless communication system to which the NR is applied is referred to as an NR system.

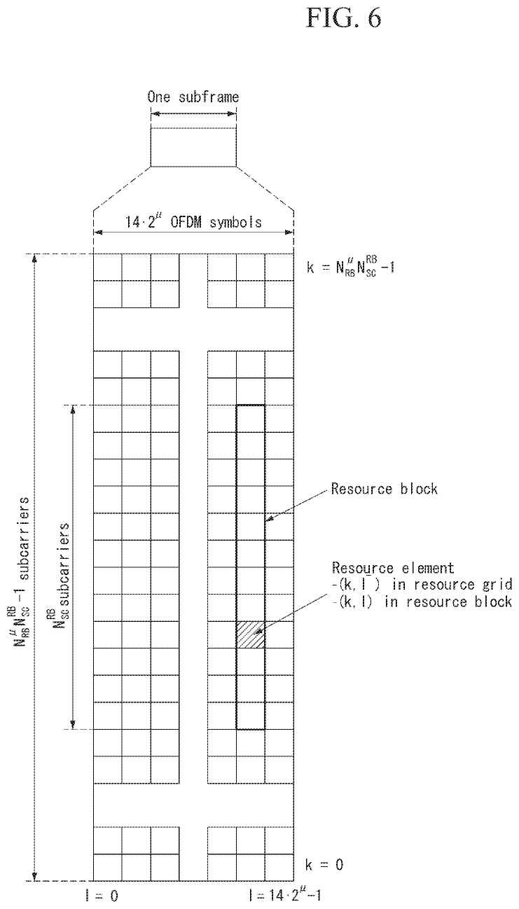

FIG. 6 illustrates an example of a resource grid supported by a wireless communication system to which a method proposed by this specification may be applied.

Referring to FIG. 6, it is exemplarily described that the resource grid is constituted by N_{RB}^{μ}N_{sc}^{RB} subcarriers on the frequency domain and one subframe is constituted by 14·2^{μ} OFDM symbols, but the present invention is not limited thereto.

In the NR system, a transmitted is described by one or more resource grids constituted by N_{RB}^{μ}N_{sc}^{RB} subcarriers and OFDM symbols of N^{μ}N_{symb}^{(μ)}. Here, N_{RB}^{μ}≤N_{RB}^{max, μ}. The N_{RB}^{max,μ} represents a maximum transmission bandwidth and this may vary between the uplink and the downlink in addition to numerologies.

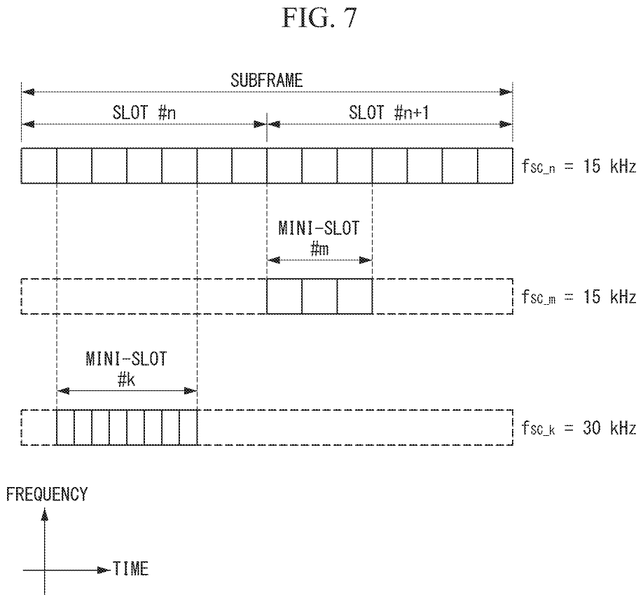

FIG. 7 illustrates an example of a radio frame structure in an NR system to which a method proposed by this specification may be applied. FIG. 7 is just for convenience of the description and does not limit the scope of the present invention.

Referring to FIG. 7, it is assumed that a reference subcarrier spacing (i.e., reference f_{SC}) is configured to 15 kHz (i.e. f_{SC}=15 kHz) and one subframe is constituted by two slots (slot #n and slot #n+1). In this case, the number of OFDM symbols constituting the slot in the case of FIG. 7 is configured to 7, but the present invention is not limited thereto. The number of OFDM symbols may be changed according to the number of symbols constituting the subframe or configured through signaling. As an example, the number of symbols constituting the slot may be configured equal to the number of symbols constituting the subframe.

In addition, in the NR system, a scheme of introducing a ‘mini-slot’ is being considered in order to utilize resources more efficiently and to reduce the time delay required for data transmission and reception. Here, the mini-slot may mean a transmission unit configured to support transmission that is shorter than the length of the slot.

In this case, the length (i.e., the number of OFDM symbols constituting the mini-slot) of the mini-slot, the position of the mini-slot, and the like may be configured flexibly. For example, a starting symbol of the mini-slot may be configured to be placed at a beginning point of a specific slot (e.g., mini-slot #m) or configured to be placed at a midpoint of a specific slot (e.g., mini-slot #k).

Further, the subcarrier spacing applied to the mini-slot may be configured equal to or different from the subcarrier spacing applied to the slot (and/or the subframe). For example, if the subcarrier spacing for the slot is configured to 15 kHz (f_{SC_n}=15 kHz), the subcarrier spacing for mini-slot #m may equally be configured to 15 kHz (f_{SC_m}=15 kHz). Alternatively, if the subcarrier spacing for the slot is configured to 15 kHz (f_{SC_n}=15 kHz), the subcarrier spacing for mini-slot #k may be configured to 30 kHz (f_{SC_k}=30 kHz).

As described above, in the next-generation communication system, a structure in which the transmission time interval (TTI) is configured to be short may be considered in order to reduce a delay time that may occur when information is transmitted/received.

Here, the transmission time interval may mean a transmission time unit (or transmission resource unit) of a signal and/or a channel. Hereinafter, for convenience of description, in this specification, the transmission time unit used in the existing LTE system is referred to as ‘TTI’, and the short transmission time unit supportable in a next generation communication system (e.g., an LTE system supporting a short TTI, an NR system, etc.) is referred to as ‘sTTI’.

As such, when the sTTI is considered in the next generation communication system, a channel (e.g., an uplink channel (UL channel) and a downlink channel (DL channel)) for transmitting data and/or control information suitable for the sTTI needs to be newly devised.

Therefore, this specification proposes configuration methods which may be considered in relation to a case where the Base station(BS) and the UE transmit and receive information through downlink (DL) in the next generation communication system supporting the sTTI.

Specifically, this specification proposes a method (first embodiment) for transmitting information in a time division multiplexing (TDM) structure between different channels in the system supporting the sTTI, a method (second embodiment) for configuring a control channel by considering the STTI, a method (third embodiment) for applying interleaver by considering a resource element group (REG), a method (fourth embodiment) for configuring a resource set for transmitting control information, a method (fifth embodiment) for configuring a search space supporting sDCI, and a method (sixth embodiment) for performing multiplexing and CSI reporting in the system supporting the sTTI.

Hereinafter, the embodiments proposed in this specification may be applied to the NR system as well as the LTE system supporting the sTTI, of course. For example, the embodiments proposed by this specification may be applied even to a case where a slot and a mini slot coexist in the NR system. In this case, the slot may correspond to the TTI and the mini slot in which the transmission unit is relatively smaller than the slot may correspond to the sTTI.

Further, hereinafter, the embodiments described in this specification are just distinguished for convenience of the description and some configurations or features of a predetermined embodiment may be included in other embodiments or may be replaced with corresponding configurations or features of other embodiments. For example, hereinafter, a scheme to be described in a third embodiment may be applied to schemes to be described in other embodiments and vice versa.

### First Embodiment—Method for Transmitting Information in TDM Structure Between Different Channels

First, a method for transmitting information in a TDM structure between different channels is described.

For convenience of description, it is assumed that the control channel and the data channel are configured in a TDM structure with each other. In this case, the following matters may be considered according to a transmission scheme of a demodulation reference signal (DMRS).

For example, in an environment where the sTTI is constituted by two symbols, the DMRS may be code division multiplexed (CDM) and transmitted over two symbols (i.e., in two consecutive symbols on the time axis) for each antenna port.

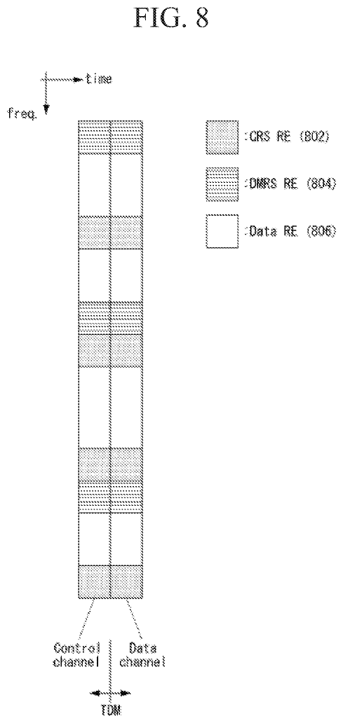

In this case, as illustrated in FIG. 8, the DMRS may be transmitted over the control channel and the data channel.

FIG. 8 illustrates an example of a method for transmitting a Demodulation Reference Signal (DMRS) in an sTTI structure to which a method proposed by this specification may be applied. FIG. 8 is just for convenience of the description and does not limit the scope of the present invention.

Referring to FIG. 8, a cell-specific reference signal (CRS) RE 802 may mean an RE to which a CRS is allocated, a DMRS RE 804 may mean an RE to which a DMRS is allocated, and a data RE 806 may an RE to which data and/or control information is allocated. Further, the numbers of symbols or RSs are not limited to the example illustrated in FIG. 8, but may be differently applied, of course.

As described above, when the DMRS is configured to be transmitted over two symbols, the corresponding DMRS may be transmitted over a control channel and a data channel.

At this time, if one channel is configured based on the CRS and the other channel is configured based on the DMRS, the DMRS for the DMRS-based transmission channel may invade a region of the CRS-based transmission channel.

For example, when the data channel is the DMRS-based transmission channel and the control channel is the CRS-based transmission channel, the DMRS for the data channel may be located in a control channel region.

In this case, for the reliability of the control information transmitted through the control channel, a method for performing rate-matching in consideration of all candidate positions where the DMRS may be transmitted on the control channel is considered. Therefore, the base station may transmit the control information according to an RE in which the RS is configured not to be transmitted according to rate-matching.

That is, when the DMRS region allocated for the data channel and a partial region of the control channel overlap with each other, the base station may be configured to transmit the control information according to a non-overlapping region based on the above-described rate matching operation.

In this case, the REG may be configured by rate-matching the REs in which the RS is configured not to be transmitted.

Alternatively, after configuring the REG without considering the corresponding REs (at least when Space Frequency Block Coding (SFBC) is used), when mapping actual control information to the RE, the corresponding REGs, that is, REGs overlapped with the DMRS allocated for the data channel may be configured not to be used.

Alternatively, an RE(s) corresponding to an orphan RE may be configured not to be used for transmission of the control information. Here, the orphan RE may refer to an RE that is located away from other RE(s) due to already allocated channels and/or signals.

In other words, even if the REs configured to transmit the RS are not used for transmission of the control information, a scheme for implementing the REs may be variously considered.

To this end, the eNB may notify to the UE whether to perform rate-matching for the corresponding resource (i.e., corresponding RE) in the control region through higher layer signaling and/or physical layer signaling.

In the above-described scheme, even when data information is not actually transmitted in the data channel, rate matching may be performed in consideration of candidate DMRS positions that may be transmitted for the data channel in the control channel. That is, even if the DMRS for the data channel is not transmitted on the control region, the RE(s) of the control channel may be wasted due to unnecessary rate matching.

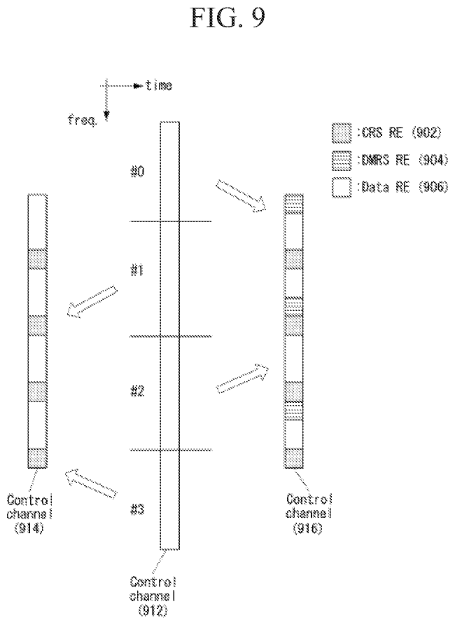

Accordingly, in order to efficiently use the RE on the control channel, the eNB may configure the resource region to be rate-matched in the control channel region through the higher layer signaling and/or physical layer signaling. An example of configuring the resource region to be rate-matched in the control channel region is illustrated in FIG. 9.

FIG. 9 illustrates an example of a method for performing rate matching for a control channel region to which a method proposed by this specification may be applied. FIG. 9 is just for convenience of the description and does not limit the scope of the present invention.

Referring to FIG. 9, a CRS RE 902, a DMRS RE 904, and a Data RE 906 have the same meanings as the CRS RE 802, the DMRS RE 804, and the Data RE 806 of FIG. 8.

In addition, the entire control channel 912 may be divided into a total of four resource regions (e.g., Resource Blocks (RBs)) and in this case, whether to perform rate-matching for the control channel may be distinguished according to the divided resource unit.

For example, when transmitting the control channel, region #0 and region #2 are configured to rate-match positions of candidate DMRS REs that may be transmitted in the data channel and region #1 and region #3 may be configured to rate-match the positions of the candidate DMRS REs which may be transmitted in the data channel.

That is, a control channel 914 transmitted in regions #1 and #3 may mean a channel in which the above rate-matching operation is not performed and a control channel 916 transmitted in regions #0 and #2 may mean a channel in which the rate-matching operation is performed.

In this case, the number of regions generated by dividing the entire control channel region is not limited four, but may be variously configured, of course.

In addition, when a scheme of transmitting downlink control information (DCI) in two or more steps (e.g., two-level DCI) is introduced, the base station configures the above-described operation through first DCI to efficiently schedule the UE. In addition, a method for configuring the above-described operation by using both the higher layer signaling and the first DCI may also be considered.

For example, in FIG. 9, the base station transmits configuration information on how many the entire band of the control channel region are divided through the higher layer signaling and a region (e.g., regions #0 and #2) to be rate-matched among the divided regions may be configured to be additionally configured through the first DCI.

Even when the control channel is the DMRS-based transmission channel and the data channel is the CRS-based transmission channel, the above-described operation may be similarly applied from the viewpoint of the data channel.

In other words, when the DMRS for the control channel is transmitted in the data channel region, the data information may be rate-matched in consideration of the candidate position of the DMRS for the control channel. In this case, the configuration related to the rate-matching may be applied in the same manner as in the above-described operation from the viewpoint of the control channel.

However, in the case of the data channel, an operation in which the DMRS for the control channel simply punctures the data channel region may also be considered. The puncturing operation may be applied even to the case of the control channel, but the puncturing operation may not be desirable in consideration of the reliability of the control channel.

In addition, in the case of the data channel, whether to rate-match the corresponding resource(s) (i.e., resource overlapping with the DMRS) may be transmitted through the DCI.

As described above, when the control channel is configured through the rate-matching, the number of available resources (i.e., available REs) is reduced compared to the case where the rate-matching is not applied.

At this time, the number of effective REs constituting the REG may be reduced according to the definition of a resource element group (REG). For example, when the REG is defined as one symbol (12 REs) in units of the resource block (RB) including another signal, the number of effective REs per REG is reduced by the above-described rate-matching operation.

In this case, a method for configuring the control channel by constituting the REG when the rate-matching operation is applied in units of multiple RBs may be considered depending on whether to rate-match the control region. That is, the size of the REG may be set differently depending on rate-matching.

In this case, the size of the REG may be set to match the number of available REs in the REG to a similar level. For example, if the number of available REs per REG is 8 when the rate-matching is not applied and the number of available REs after the rate matching is 5, the REG may be defined to be configured in units of 2 RBs including other signals.

If multiple REGs are configured as one Control Channel Element (CCE), instead of changing the size of the REG according to rate-matching, the number of REGs constituting one CCE may be changed.

Alternatively, an aggregation level (AL) may be defined differently according to whether the rate-matching operation is applied while the definition of the REG is maintained as it is. An example of defining the AL differently according to the rate-matching may be shown in Table 3.

TABLE 3
Search space Sₖ^{(L)}

| Type | Aggregation level L | Size [in CCEs] |
|---|---|---|
| No Rate-matching | 1 | 6 |
| | 2 | 12 |
| | 4 | 8 |
| | 8 | 16 |
| Rate-matching | 2 | 12 |
| | 4 | 24 |
| | 8 | 16 |
| | 16 | 32 |

Such a configuration may be implicitly made by combining with (or mapping to) the configuration information indicating whether the rate-matching is performed, which the eNB transmits to the UE. Alternatively, the eNB may deliver to the UE configuration information on whether the rate-matching is performed and/or the number of REs per REG available after the rate-matching. Such configuration information may be delivered through the higher layer signaling and/or physical layer signaling.

As described above, whether to apply the scheme of changing the size of the REG, the number of REGs constituting the CCE, and/or the AL of the CCE may vary depending on a transmission scheme.

For example, when the control channel may be transmitted in a 1 port beamforming scheme and a Space Frequency Block Coding (SFBC) scheme, the above-described methods may be configured to be applied when the SFBC scheme is used and configured not to be applied when the 1 port beamforming scheme is used. The corresponding example which is used for convenience of description may be applied even when other types of transmission schemes are present and whether to apply the example may be applied to combinations different from the above example.

Further, whether to apply the scheme of changing the size of the REG, the number of REGs constituting the CCE, and/or the AL of the CCE may be configured differently according to a mapping structure (e.g., a distributed mapping structure, and a localized mapping structure).

For example, the above-described methods may be applied to the distributed mapping structure and not to the localized mapping structure.

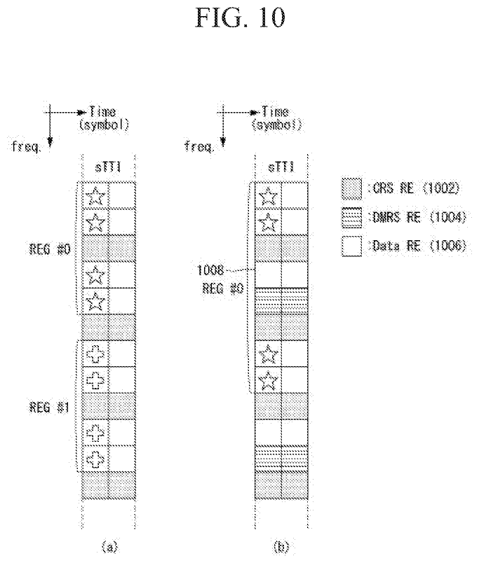

Alternatively, the REG may be constituted by REs other than the RE(s) to which the rate-matching is applied and the resulting orphan RE(s). In this regard, an example corresponding to a case where the number of effective REs is 4 at the time constituting the REG may be illustrated in FIG. 10.

FIG. 10 illustrates an example of an REG configuration to which a method proposed by this specification may be applied. FIG. 10 is just for convenience of the description and does not limit the scope of the present invention.

Referring to FIG. 10, FIG. 10(a) illustrates a REG configuration when rate-matching is not performed for the DMRS RE and FIG. 10(b) illustrates a REG configuration when rate-matching is performed for the DMRS RE.

In addition, a CRS RE 1002, a DMRS RE 1004, and a data RE 1006 of FIG. 10 are the same as those described in FIGS. 8 and 9, and it is assumed that the number of valid REs existing in the REG is set to four.

Referring to FIG. 10(a), the REG may be configured of five REs including four effective REs in consideration of the CRS RE 1002.

In contrast, referring to FIG. 10(b), the REG may be configured of eight REs including four effective REs in consideration of the CRS RE 1002, the DMRS RE 1004, and the orphan RE 1008.

As such, the number of REs constituting the REG may be set differently according to whether the rate-matching is performed.

When such a scheme is used, the REG may be configured beyond an RB boundary. Further, RE(s) may be generated which remain even after the physical resource block (PRB) is filled in the resource set of the configured control region.

When the REG is beyond the RB boundary (or is configured across the RB boundary), there is no limit on the resource region of the control channel (i.e., may be configured over the entire band) and when the control information is transmitted through the CRS-based transmission channel, the UE may decode the control information without any problem. In contrast, when the control information is transmitted through the DMRS-based transmission channel, the number of DMRSs for decoding the control information may be insufficient as the resource region of the control channel is out of the RB unit. In this case, the reliability of decoding performed by the UE may be lowered.

In addition, even when the eNB designates a frequency domain in which the UE attempts decoding through the higher layer signaling and/or physical layer signaling, it is necessary to separately process the REG beyond the RB boundary. For example, in this case, the REG beyond the RB boundary may be configured not to be used.

As an example, in order to solve the above problem, when the number of valid REs is designated as 4, the REG unit may be configured in the following scheme.

When the number of valid REs which are present in one PRB in one OFDM symbol is less than 4 (e.g., 0 or 2), the corresponding PRB may be excluded from the REG configuration. The PRB thus excluded may be used for data mapping without an additional indication.

Alternatively, when the number of valid REs which are present in one PRB is equal to or larger than 4 and smaller than 8 (e.g., 4 or 6), one PRB may correspond to one REG.

Alternatively, when the number of valid REs present in one PRB is 8 or 10, two REGs may be configured in one PRB. In this case, one REG is constituted by 6 REs.

Alternatively, when the number of valid REs present in one PRB is 2, 6 or 10, the REG may correspond to an REG constituted by 2 REs, an REG constituted by 6 (4+2) REs, and/or an REG constituted by 10 (4+4+2) REs.

Alternatively, when the number of valid REs present in one PRB is 12, three REGs may be configured in one PRB.

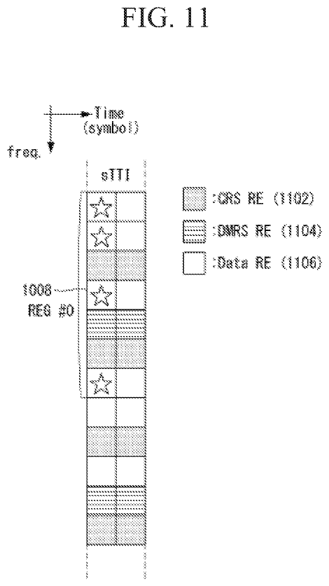

In addition to the above-described method, a method may also be considered, in which the rate-matching is be applied to other signals (e.g., RS), but the orphan RE is utilized for the REG configuration. An example of the method is illustrated in FIG. 11.

FIG. 11 illustrates another example of an REG configuration to which a method proposed by this specification may be applied. FIG. 11 is just for convenience of the description and does not limit the scope of the present invention.

A CRS RE 1102, a DMRS RE 1104, and a data RE 1106 of FIG. 11 are the same as those described in FIGS. 8 to 10, and it is assumed that the number of valid REs existing in the REG is set to four.

Referring to FIG. 11, the rate-matching may be applied to the DMRS RE 1104, and an orphan RE 1108 may be used for the REG configuration.

In this case, SFBC may be applied using two adjacent REs or two spaced REs.

Further, in addition to the above-described method, a method for differently applying the rate-matching according to RS may also be considered.

In the case of the communication system supporting the sTTI, the type of RS may be differently applied for each sTTI. Specifically, in consideration of compatibility with the legacy LTE UE, the CRS and the DMRS may be transmitted in the first sTTI and the DMRS and the CSI-RS may be transmitted in the second sTTI. In this case, the rate-matching may be applied differently according to the RS when configuring the REG.

For example, a method may be considered in which in the first sTTI in which the CRS and the DMRS are transmitted, the REG is configured by applying the rate-matching to the CRS and when the DMRS is transmitted to a specific RE within the REG, the REs is not used. At this time, when the orphan RE is generated, the orphan RE may also be configured not to be used.

Further, even in the case where the CRS and the CSI-RS are transmitted, a method may be considered in which the REG is configured by applying the rate-matching to the CRS and when the CSI-RS is transmitted to the specific RE in the corresponding REG, the corresponding RE is not used.

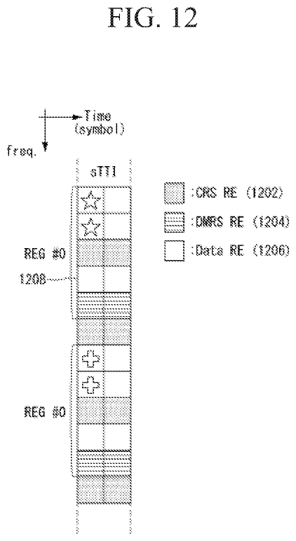

FIG. 12 illustrates yet another example of an REG configuration to which a method proposed by this specification may be applied. FIG. 12 is just for convenience of the description and does not limit the scope of the present invention.

A CRS RE 1202, a DMRS RE 2104, and a data RE 2106 of FIG. 12 are the same as those described in FIGS. 8 to 11, and it is assumed that the number of valid REs existing in the REG is set to two.

In the case of FIG. 12, as the rate-matching is applied to the CRS RE 1202, the CRS RE 1202, the DMRS 1204, and an orphan RE 1208 are not used in the REG configuration.

Accordingly, each REG is configured in units of 5 REs including two valid REs.

### Second Embodiment—Method for Configuring Control Channel by Using sTTI

Next, a method for configuring the control channel in consideration of a shorter transmission unit shorter than the legacy in the system supporting the sTTI will be described.

The contents of the first embodiment described above show an operation of rate-matching information (i.e., data or control information) to be transmitted in consideration of the DMRS for another channel that may be transmitted on one channel.

Similarly, even when another signal such as the CSI-RS is transmitted according to the position of the sTTI, considering the position of another signal transmitted on the control channel region, the operation of rate-matching the control information transmitted through the control channel may be considered. This may be applied not only to the case where the control channel and the data channel are TDMed, but also to the control channel and the data channel are FDMed and may also be applied in terms of the data channel.

However, when information is transmitted through the control channel by applying the rate-matching as described above, considering the compatibility with the operation of the existing legacy UE, the number of REs available for each sTTI may be different.

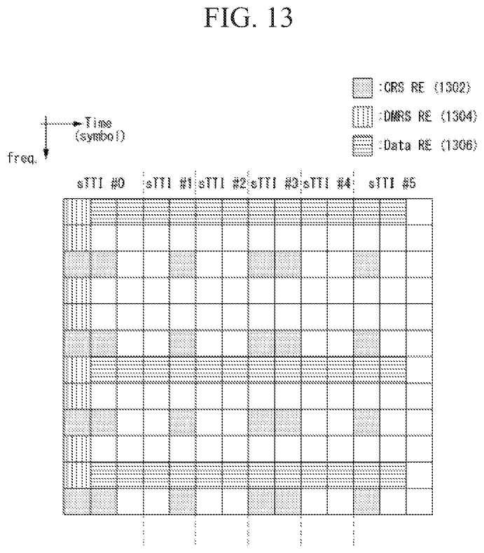

FIG. 13 illustrates an example of a resource grid to which a DMRS for an sTTI is applied to which a method proposed by this specification may be applied. FIG. 13 is just for convenience of the description and does not limit the scope of the present invention.

Referring to FIG. 13, due to a CRS RE 1302, a PDCCH 1304, and a DMRS 1306 mapped to the resource grid, the number of available REs may be set differently for each sTTI.

In addition, when even the transmission of another signal such as the CSI-RS is considered, the difference in the number of REs available for each sTTI may be larger.

According to the above-described configuration scheme of the control channel region, by the definition of REG, which is a basic unit constituting the control channel, the number of REs per REG may be smaller than that in the case where the rate-matching is not applied.

For example, when REG is constituted by four consecutive REs that do not include another signal, such as the legacy LTE system, the number of REs per REG is configured to be constant. However, when the REG is defined as one symbol of RB unit (i.e., 12 REs) including another signal, if the rate-matching is applied, the REG configuration may be made differently for each symbol according to transmission position of another signal.

In this case, in the example of the sTTI unit constituted by two symbols, if the CSI-RS is transmitted in sTTI #2, sTTI #4, and sTTI #5, the number of REs constituting the sTTI may be configured very little according to the configuration. In this case, the number of REs constituting the REG defined as one symbol of RB unit including another signal may be set very small compared with another sTTI.

By considering such a configuration, the definition of the REG related to the control channel may be configured differently for each sTTI.

For example, for the sTTIs where the CSI-RS may be transmitted, such as sTTI #2, sTTI #4, or sTTI #5, the REG may be defined in units of 2 RB or 3 RB in consideration of the number of available REs determined according to the CSI-RS configuration.

Such a method is not limited to sTTI #2, sTTI #4, and sTTI #5, and the REG unit may be configured differently for each sTTI, of course.

At this time, based on the number of REs per REG in a specific sTTI in which no other signal is transmitted, the REG may be predefined in the system to be configured to the number of REs close to the number of REs per REG. Alternatively, the eNB may transmit information on the REG definition to the UE through the higher layer signaling and/or physical layer signaling.

Alternatively, instead of the method for applying (or configuring) the REG definition differently for each sTTI, a method may also be considered in which the number of REs per REG is defined constantly regardless of another signal transmitted from each sTTI and the AL is configured differently for each sTTI.

In this case, the AL may be applied differently according to whether different signals are transmitted for each sTTI and/or the number of available REs.

Such configuration may be predefined in the system, or the eNB may deliver information on the configuration through the higher layer signaling and/or physical layer signaling.

In addition, when one or more control resource sets (i.e., control resource sets, CORESET) are designated through the higher layer signaling and/or physical layer signaling, the number of candidate RBs for each resource set may be determined. In this case, the configuration for the number of candidate RBs may be applied differently for each sTTI.

That is, the UE may be configured multiple sets for the number of candidate RBs and may apply the configured multiple sets differently for each sTTI. Additionally, the UE may be configured one set and offset values and infer multiple sets based on one set.

For example, the UE may be configured sets of {x, y, z} and {a, b, c} through the higher layer signaling and/or physical layer signaling. The UE may apply the number of available RB which may constitute the control resource set as {x, y, z} in the sTTI having a large number of REs available and apply {a, b, c} in the sTTI having a small number of REs available.

In this case, the UE may be directly configured {a, b, c} through the higher layer signaling and/or physical layer signaling or may infer {a, b, c} by applying the offset value.

For example, the resource set may be configured by adjusting a ratio such as x*p, y*p, z*p in consideration of the number of available REs.

Of course, the number of sets of the number of candidate RBs in the above examples is not limited to a specific value.

As illustrated in FIG. 13, when the DMRS is transmitted in the sTTI, the control channel and/or the data channel may be transmitted based on the DMRS using the corresponding DMRS.

In order to apply the SFBC in the control channel, the REs in the REG need to be configured in two or four pairs adjacent to the frequency axis. At this time, a case may occur in which the number of REs constituting the REG is not configured by two or four multiples according to the definition of the REG.

For example, when the REG is defined as one symbol of RB unit (i.e. 12 REs) including another signal, the RE available as the REG on the control channel depending on whether another signal (e.g., DMRS or CSI-RS) is transmitted may be constituted by an odd number.

Specifically, in the case of sTTI #1 of FIG. 13, the REG of the first symbol may be constituted by 9 REs and the REG of the second symbol may be constituted by 5 REs. In this case, when pairing with two or four REs, one RE is left in each pair.

Therefore, in order to apply the SFBC, a method for not using an odd number of (e.g., one) remaining REs in the corresponding REG or using a REG unit not constituted by two or four REs may be considered.

However, since multiple REs may be wasted for each RB in the corresponding symbol, a method for configuring different definitions of REGs for each of the aforementioned sTTIs may be additionally applied. For example, in an sTTI in which an odd number of RE(s) is left, the REG is configured in units of 2 RBs or 4 RBs including another signal to maintain the number of REs constituting the REG in a multiple of 2 or a multiple of 4 to apply the SFBC.

Such a method may be applied even when the number of available REs in one REG is smaller than two or four. In addition, the method may be applied not only to the case where the control channel and the data channel are TDMed, but also to the case where the control channel and the data channel are FDMed.

In addition, although the RS for the control channel is configured and transmitted for four ports, the control channel in the sTTI operation may be configured to use only some of four ports (e.g., two ports).

### Third Embodiment—Method for Applying Interleaver by Considering REG

Next, a method for applying (or configuring) an interleaver (e.g., an interleaver for DCI) in consideration of the above-described REG unit will be described.

As mentioned above, a method for transmitting DCI in multiple steps (e.g., twp steps) in the communication system supporting the sTTI may be considered. Hereinafter, for convenience of description, the method will be described by assuming a case where the DCI is transmitted in two steps.

At this time, the base station may transmit additional information available when decoding the second DCI through the first DCI. Here, the additional information may be information that may be helpful when decoding the second DCI (e.g., information for reducing search space or the number of blind decoding (BD) times).

For example, the search space for the control channel may be basically configured for the entire band, and the base station may define (i.e., limitatively configure) the frequency domain in which the second DCI is to be decoded through the first DCI. Alternatively, after the base station primarily defines the frequency domain through the higher layer signaling, the eNB may additionally limit the frequency domain to decode the second DCI through the first DCI.

At this time, when the UE does not properly receive the first DCI, confusion may occur in the interpretation of the resource region of the control channel between the UE and the base station.

Specifically, when interleaving is applied in units of REG such as legacy LTE when transmitting control information, interpretation of an actual physical location to which REGs are mapped may be differently applied according to the frequency domain to which the interleaving is applied. Here, the physical location may refer to a resource location indicated by a physical index actually applied in the physical layer, not a logical index by a higher layer message.

For example, it is assumed that the base station transmits the control information in a scheme of defining the frequency domain in which the UE decodes the second DCI through the first DCI and then performing interleaving based on the defined frequency domain and mapping the REG to the physical resource (i.e., a resource on the physical layer).

In this case, when the UE does not receive the first DCI, the UE may perform a blind decoding (BD) based on the physical resource to which interleaving is applied based on a primarily defined frequency domain through the entire system band or the higher layer signaling. In this case, a mismatch between the physical resource of the REG actually transmitted by the base station and the physical resource where the UE performs the BD may occur, and thus, control information may not be decoded.

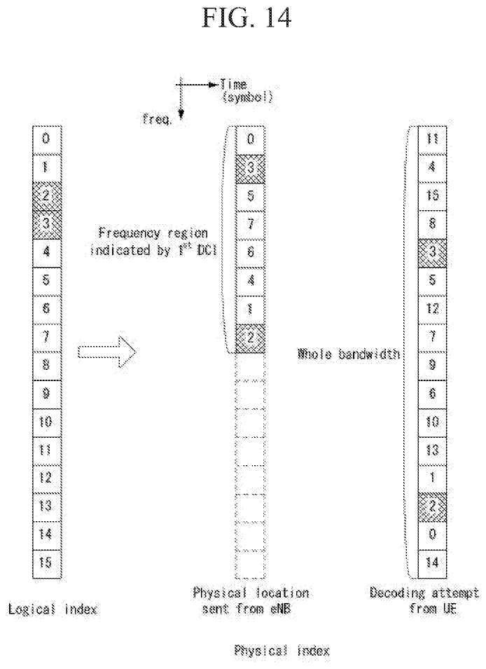

FIG. 14 illustrates an example of an interleaving scheme to which a method used in a legacy system may be applied. FIG. 14 is just for convenience of the description and does not limit the scope of the present invention.

In FIG. 14, one rectangle means one REG, and it is assumed that the UE is configured the frequency domain for performing the BD through two levels of DCI.

In the example described below, it is assumed that the base station uses two REGs (i.e., REG #2 and REG #3) to be used for transmission of the control information. This is merely for convenience of description, and the method described in this specification may be applied even to a case where multiple REGs are transmitted, and the method may be similarly applied even to a case where interleaving of a CCE level is performed rather than interleaving of REG unit.

In this case, the base station may perform interleaving based on the frequency domain previously configured through the first DCI and transmit the control information through the physical resources corresponding to REG #2 and REG #3.

In this case, when the UE does not receive the first DCI and does not receive the information on the reduced frequency range (e.g., 8 REGs), the UE may apply the interleaving based on the entire band or the band primarily configured through the higher layer signaling. FIG. 14 illustrates an example in which the UE applies interleaving based on the entire band.

Accordingly, the UE attempts to decode REG #2 and REG #3 based on a frequency band different from that of the base station, so that a mismatch in interpretation of the physical location (i.e., a resource location in the physical layer) between the eNB and the UE occurs.

Accordingly, in order to prevent the mismatch as described above, a method for interleaving the REGs based on a specific frequency domain size and configuring the entire band by repeating such an interleaving pattern may be considered.

In this case, a reference frequency domain size may be referred to as a basic unit.

For example, the basic unit may be set to a smallest size among the size candidates of the resource region for decoding of the second DCI that may be designated through the first DCI. In this case, even if the UE does not receive the first DCI and decodes the primarily defined frequency domain through the entire band or the higher layer signaling, the interpretation of the position of the physical resource that attempts decoding matches between the base station and the UE.

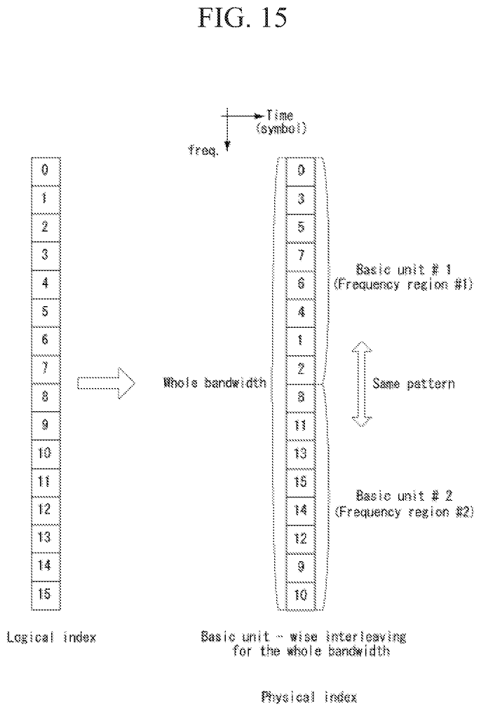

FIG. 15 illustrates an example of an interleaving scheme to which a method proposed by this specification may be applied. FIG. 15 is just for convenience of the description and does not limit the scope of the present invention.

Referring to FIG. 15, it is assumed that the base station and the UE perform interleaving based on the basic unit and the basic unit is configured to the frequency band corresponding to eight REGs.

Specifically, when the UE is allocated the frequency domain to attempt decoding through the first DCI or the like, the UE may perform interleaving in consideration of the size of the frequency domain. For example, when the size of the corresponding frequency domain corresponds to the above-described basic unit, resource indexing may be performed by applying interleaving of the basic unit.

In this case, a method for performing resource indexing using an offset according to a position on an actual frequency axis of the corresponding region may be considered.

For example, when the size of the frequency domain allocated to the UE corresponds to one basic unit in FIG. 15, interleaving in units of the basic unit may be performed using indexes from 0 to 7 to match the number of indexes corresponding to the size. In this case, when the position on actual frequency axis of the corresponding domain corresponds to frequency region #2 of FIG. 15, an offset value (i.e., 8) is added to the index for performing the interleaving to refer to the actual position.

Here, the offset value may be determined using the size of the basic unit and the index of the frequency region actually allocated.

The above-described methods may be applied even to a case of performing interleaving at the REG level and may also be applied to the case of interleaving at the CCE level without applying the interleaving at the REG level.

In addition, although the interleaving of one symbol unit has been described in the above-described methods for convenience of description, the same may be applied to a symbol unit constituted by multiple symbols.

### Fourth Embodiment—Method for Configuring Resource Set for Transmission of Control Information

The eNB may configure the resource region for the UE to monitor the control information. In this case, a method in which the eNB configures multiple resource sets for transmission of the control information may be considered.

Here, the resource set may be referred to as a resource block set (RB set), a control resource set (CORESET), etc., for the transmission of the control information.

In this case, each resource set may be configured to have a localized structure or a distributed structure.

Further, in order to transmit the resource set, various transmission schemes (e.g., beamforming scheme, a Tx diversity scheme, etc.) may be considered.

For example, when the base station configures multiple resource sets in the UE, each resource set may be configured to operate by the beamforming scheme or a Tx diversity scheme. Specifically, when the resource set is configured to be configured by the Tx diversity scheme, the resource block may be configured to operate in an SFBC scheme, a precoder cycling scheme, or a cyclic delay diversity (CDD) scheme.

In addition, each resource set may be configured to operate in the CRS-based transmission scheme or the DMRS-based transmission scheme.

Further, each resource set may be configured to operate with a combination of the above-described matters.

For example, when the base station configures multiple resource sets in the UE, a first resource set may be configured to operate with one port beamforming in the localized structure and a second resource set may be configured to operate in the SFBC among the Tx diversity schemes in the distributed structure.

The resource set in the localized structure may be preferably configured to operate the beamforming scheme. However, in the case where the measurement of the channel state is inaccurate (i.e., the case where channel state information (CSI) is inaccurate), the resource set may be configured to operate in the Tx diversity scheme even in the localized structure.

In this case, the eNB may deliver configuration information related to the above-described matters to the UE through the higher layer signaling and/or physical layer signaling. Here, the above-described configurations may be applied differently for each sTTI.

Further, multiple resource sets may be configured for one UE and the multiple resource sets may be configured semi-statically through the higher layer signaling.

In this case, some of multiple resource sets configured for transmission of the control channel may be configured to be used for data transmission. For example, the configuration information indicating the multiple resource sets may be referred to as first resource allocation information and configuration information indicating some of the multiple resource sets may be referred to as second resource allocation information.

Such configuration information may be delivered to the UE by the base station and may be delivered through the higher layer signaling and/or physical layer signaling (e.g., downlink control information (DCI)). In other words, information indicating that some of the resource sets configured for transmission of the control information are available for transmission of data may be delivered to the UE in a semi-static scheme or in a dynamic scheme.

For example, the base station may configure multiple resource sets through the higher layer signaling and some of the resource sets may be semi-statically configured through the higher layer signaling to be used for data transmission.

As another example, the base station may configure multiple resource sets through the higher layer signaling and some of the resource sets may be dynamically configured through the physical layer signaling (e.g., DCI) to be used for data transmission.

In the above-described method, when configuring multiple resource sets, some may be configured as a resource set (e.g., control RB set) for transmission of control information and others may be configured as a reserved resource set (e.g., reserved RB set).

Here, the reserved resource set may refer to a resource set that is configured to prevent data (e.g., sPDSCH) transmission from being performed in a reserved resource set in which the corresponding UE is activated when the corresponding resource set is activated.

In this case, the reserved resource set may be configured similarly to the configuration of the resource set for transmission of control information. For example, when the resource set for transmission of control information is configured in units of multiple RBs and configured through the higher layer signaling, the reserved resource set may also be configured in the same scheme as above.

In addition, the reserved resource set may be configured in the same scheme as the resource allocation scheme of data. For example, when data is resource-allocated in units of resource block group (RBG), the reserved resource set may also be allocated in units of RBG, which may be similarly applied to the resource set for transmission of control information.

Further, the reserved resource set and/or the resource set for transmission of control information may be allocated in a compact resource allocation scheme. Here, the compact resource allocation scheme may mean a scheme of allocating a start RB and the number of consecutive RBs from the start RB.

Alternatively, the reserved resource set may be allocated in a separate scheme from the resource set for transmission of data and/or control information.

For example, after the scheme of allocating the reserved resource set is predefined as multiple types, the eNB may configure the reserved resource set using at least one of multiple types. Here, the multiple types may include an RBG resource allocation scheme, a compact resource allocation scheme, and the like.

In addition, the structure (e.g., localized structure, distributed structure) of the mapping of the control channel, a transmission scheme (e.g., CRS based or DMRS based) of the RS for demodulation of the control channel, and a transmission scheme (e.g., SFBC, precoder cycling, beamforming, etc.) of the control channel may be configured for each resource set.

In this case, when a specific resource set is configured as a mapping and/or transmission scheme for a CRS basis or CRS-based control channel, a predefined configuration other than the configuration by the base station may be used in a specific (s)TTI in a multicast-broadcast single frequency network (MBSFN) subframe.

Here, the mapping and/or transmission scheme for the CRS-based control channel may correspond to distributed mapping and/or CRS-based SFBC. In addition, the measurement (s)TTI may correspond to an (s)TTI in which no CRS exists in the MBSFN subframe.

Specifically, in this case, the eNB transmits the control channel according to a predefined (different) control channel mapping scheme, a demodulation RS, and/or a transmission scheme, without following the configuration in the corresponding resource set, and the UE may be predefined (on the system) so as to decode the control channel accordingly.

For example, when CRS-based SFBC and/or distributed mapping is configured for a specific resource set, in an sTTI where no CRS is present in the MBSFN subframe, the sPDCCH of that resource set may be predefined to apply DMRS-based beamforming and/or localized mapping.

If the number of symbols on different time domains may be set for the CRS-based control channel and the DMRS-based control channel, the number of symbols in the time domain of the control channel transmitted by a predefined (different) control channel mapping, demodulation RS, and/or transmission scheme may be defined on the system. Alternatively, a separate value corresponding to the number of symbols may be configured through the higher layer signaling. Alternatively, when transmitting the DMRS-based control channel, the base station may be configured to follow THE number of symbols on a default time domain previously set (or promised) or to follow a value of another resource set configured based on the DMRS.

At this time, the definition of REG, the definition of CCE, and/or interleaver function defined in CRS-based transmission and DMRS-based transmission may be different. Even in this case, the UE may attempt decoding of a search space designated according to a hashing function according to the REG, CCE, and/or interleaver function defined in each transmission scheme (i.e., CRS-based transmission or DMRS-based transmission).

This may be similarly applied even when the number (i.e., duration) of symbols of a resource set configured for CRS-based transmission and DMRS-based transmission in the system is different.

For example, when multiple resource sets configured for the UE are all configured by the CRS-based transmission scheme, the UE may operate in the methods described above.

On the contrary, when there is a resource set configured in the DMRS based transmission scheme among the multiple resource sets, the UE may be configured not to use the CRS based configured resource set in the MBSFN subframe. In this case, the UE may be configured to additionally perform the BD in the remaining resource set while maintaining the total number of BDs by evenly dividing the number of candidate blind decodings (BDs) which are allocated to the resource set for the CRS based transmission not used to the resource set for the DMRS based transmission.

Specifically, when the resource set is configured, the UE may perform the BD for each resource set. At this time, the number of candidate BDs may be allocated to each resource set and the value may be a value defined in the system or may be allocated through the higher layer signaling.

If the number of candidate BDs for each resource set is defined in the system, the BD number may be adjusted for each resource set through the higher layer signaling. For example, when two resource sets are configured in the UE, a specific ratio (e.g., 33%, 66%, etc.) may be set for each resource set to adjust the number of candidate BDs defined in the existing system for each resource set.

As an example, when the UE receives the CRS-based resource set and the DMRS-based resource set, the following methods may be considered according to the method for determining the BD number of the UE.

First, the case where the BD number of the UE is set based on a 1 ms subframe or a long TTI will be described. In this case, the UE assumes that both resource sets may be activated in a general subframe, but in the case of the MBSFN, only the DMRS based RB set may be activated from the second sTTI.

In order to set the total sum of the BDs to N, the BD may be divided into two resource sets according to a predetermined ratio or number in the general subframe, and the MBSFN subframe may be evenly distributed among one CRS based resource set and M DMRS resource sets.

In addition, the case where the BD number of the UE is set based on the sTTI will be described. In this case, the BD distribution of the CRS based resource set and the DMRS resource set may be changed according to the general subframe or the MBSFN subframe.

In addition, in the sTTI where the CRS exists in the general subframe or the MBSFN subframe, the DMRS resource set may be deactivated, and in this case, BD handling may be applied similarly to the above-described scheme.

### Fifth Embodiment—Method for Configuring Search Space for sDCI

Next, a method for configuring the search space for sDCI will be described. Here, the sDCI may mean a DCI defined in consideration of the sTTI.

In an environment in which an operation of an sTTI unit and an operation of an TTI unit coexist (e.g., when a legacy TTI operation and an sTTI operation coexist in an LTE system), a DCI for indicating a TTI through a legacy control channel (e.g., PDCCH) and a DCI for indicating the sTTI operation may be both transmitted.

In this case, even if the UE decodes the control information in the legacy control channel region, it is necessary to determine whether the information is a DCI for indicating the legacy TTI operation or sDCI for indicating the sTTI operation.

If the sizes of the DCI and the sDCI are configured differently, the UE may perform blind decoding (BD) for each size to determine whether the corresponding information is the sDCI or the DCI. In this case, however, the number of BDs required by the UE is doubled.

On the contrary, when the sizes of the sDCI and the DCI are identically configured to reduce the number of BDs, a method for determining whether the corresponding information is the sDCI or the DCI is additionally required.

In this case, a method of distinguishing a search space defined for the DCI and a search space defined for the sDCI may be considered. Such a search space may be a UE-specific search space.

Hereinafter, a method for configuring the search space for the sDCI will be described.

First, in order to maintain the same number of BDs as the legacy UE, a method for maintaining the same number of candidate search spaces per UE as the legacy system and allocating some of the candidate search spaces for the sDCI may be considered. In other words, a method of using some of the search spaces configured for the existing DCI for the sDCI will be described.

For example, when the search space for the UE is defined by multiple candidate BDs, a method of using some of the multiple candidate BDs as the search space for the DCI and using the rest as the sDCI may be considered. Here, the hashing function used in the legacy system to configure the search space may be utilized as it is. Therefore, the base station may inform the UE of the reference point and the number for determining the candidate for the sDCI among multiple candidates in the designated search space.

Specifically, the base station may configure the reference point for the sDCI as a first candidate among the candidate BDs in the search space and designate how many candidates are used for the sDCI from the reference point. Alternatively, the base station may inform the ratio between the number of candidates for the sDCI and the number of candidates for the DCI among the total candidate BDs.

For example, if the base station informs the UE of information such as 3:3 or 50%, the UE may attempt BD as the search space for the DCI for the first half of the candidate BDs and attempt the BD as the search space for the sDCI for the latter half. In this case, the order may be predefined in the system or delivered through the higher layer signaling and/or physical layer signaling.

The above-described configuration may be delivered to the UE through the higher layer signaling and/or physical layer signaling by the base station.

Through the above-described method, the UE may determine whether the corresponding information is the DCI or the sDCI through the search space when decoding is successful without setting a separate field (e.g., indication field) in the DCI and the sDCI or distinguishing the DCI or the sDCI with an identifier (e.g., RNTI).

Alternatively, a method for separately configuring the search space for the DCI and the search space for the sDCI may be considered. In this case, a larger number of candidate BDs may be configured than the number of candidate BDs defined per UE in the legacy system.

For example, when the legacy UE has six candidate BDs in the search space for the DCI, two candidate BDs for the sDCI may be additionally configured apart therefrom. In this case, the hashing function used in the legacy system may be used as it is.

Specifically, the base station may separately allocate the RNTI for the legacy TTI and RNTI (e.g., sRNTI) for the sTTI to each UE and separately allocate candidates for sDCI by using the RNTI value as an input of the hashing function. That is, the search space for the DCI and the search space for the sDCI may be distinguished by setting different RNTI values.

In addition, the base station may allocate the candidate value for the sDCI by utilizing a value obtained by adding a predetermined offset value to the RNTI for the legacy TTI as the input of the hashing function. That is, the search space for the DCI and the search space for the sDCI may be distinguished by using the offset value to be applied to the legacy RNTI value.

Further, a method for allocating the index of the candidate for the sDCI consecutively to a last index of the DCI candidate may also be considered.

Alternatively, a method for sharing multiple candidate BDs of the search space without distinguishing between the DCI and the sDCI may also be considered. In this case, in order to distinguish whether information which the UE succeeds in BD in the search space is the DCI or the sDCI, a separate field (e.g., indication field) may be configured in the DCI and/or sDCI or the distinguished RNTI may be used.

Although the above-described methods have been described on the assumption that the ALs of the CCEs are configured as one, the above-described methods may be applied to the candidate BDs allocated for each AL even when there are multiple ALs. In addition, of course, the number of candidate BDs to be allocated is not limited to the above-described example.

In addition, a method for setting, by the base station to the UE, the number of BDs for each AL in consideration of the capability of the UE may also be considered. For such an operation, the corresponding UE may report information on the capability to the base station.

In this case, the reported capability information may be the number of BDs which may be performed by the UE for a predetermined time (e.g., TTI unit, subframe unit, etc.) and/or a processing time of the UE. Specifically, in the case of the number of BDs, the UE may inform the total number of BDs which the UE may perform for a predetermined time or may separately inform the number of BDs for each AL.

The base station receiving the information may set the number of BDs to be performed by the corresponding UE for each AL in consideration of a link (or channel) state of the UE.

### Sixth Embodiment—Method for Performing Multiplexing and CSI Reporting in System Supporting sTTI

Next, a method for performing multiplexing in the system supporting the sTTI will be described. In particular, a method for efficiently performing multiplexing between sTTIs having different lengths in one carrier is described.

For example, a case is assumed in which an sTTI (i.e., seven symbol sTTI) constituted by seven symbols and an sTTI (i.e., two symbol sTTI) constituted by two symbols coexist. In this case, the transmission region of the 7 symbol sTTI and the transmission region of the 2 symbol sTTI may be scheduled to overlap each other without FDM.

At this time, the base station may inform the UE of the longer sTTI (e.g., 7 symbol sTTI) of the rate-matching pattern for the region where the information of the shorter sTTI is transmitted.

This may be applied regardless of the type of channel. Specifically, the control channel and/or data channel of the 2 symbol sTTI may be transmitted in the data channel region of the 7 symbol sTTI, of course.

Through the above-described method, the base station may efficiently multiplex UEs operating with different lengths of sTTIs without unnecessary restriction in scheduling.

In addition, the UE operation in the sTTI may coexist with the existing legacy TTI operation (i.e., TTI operation). For the sTTI operation, the size of the short RBG (sRBG) on the frequency axis for the sTTI operation may be set larger than that of the legacy system, as the time axis is reduced in comparison with the TTI of the legacy system. Here, the sRBG may mean a resource allocation unit in the sTTI system.

In this case, the UE may report the CSI for M best subbands based on the legacy system, and multiple legacy subbands may correspond to one sRBG for the sTTI. That is, since a unit on the frequency domain of the sTTI may be set larger than that of the legacy TTI, multiple legacy subbands may be included in one sTTI subband.

In this case, CSI reporting for some sRBGs may not be performed based on the sTTI.

Therefore, a method of using a bandwidth part defined for CSI reporting in the legacy LTE system as the resource allocation unit (i.e., sRBG) of the sTTI according to a system bandwidth may be considered. When a best-1 subband reporting mode considering the bandwidth part of the CSI reporting mode is used, the base station may receive the CSI report in each sRBG unit of the sTTI.

Alternatively, in an additional mode, the base station (or UE) may be configured to feed back (or report) an average value for the CSI of the subbands constituting the bandwidth part.

The base station may deliver information indicating a change in CSI reporting mode to the UE through the higher layer signaling and/or physical layer signaling.

Hereinafter, by considering the above-described embodiments, a procedure of configuring the resource of the control channel in the wireless communication system supporting a short transmission time unit will be described.

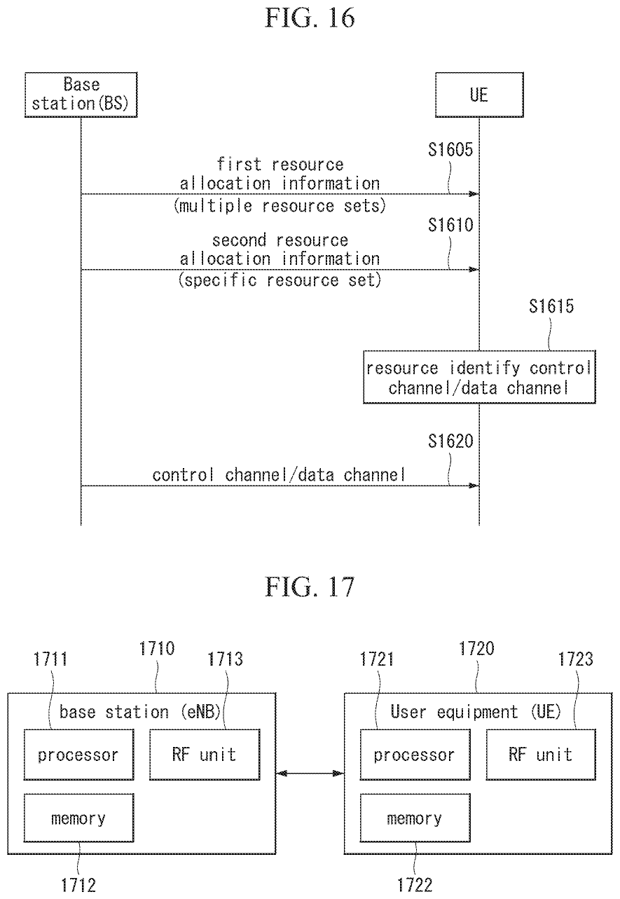

Here, the short transmission time unit may correspond to a mini-slot supported in the sTTI or the NR system supported in the LTE system. For example, hereinafter, a downlink control channel and a downlink data channel mentioned in the description of FIG. 16 may be configured according to a transmission time unit set to a number smaller than 14 OFDM symbols.

FIG. 16 illustrates an example of signaling between a base station and a UE for configuring a resource of a control channel in a wireless communication system supporting a short transmission time unit to which a method proposed by this specification may be applied. FIG. 16 is just for convenience of the description and does not limit the scope of the present invention.

In step S1605, the user equipment (UE) may receive first resource allocation information associated with the resource region of the control channel from the base station (BS). Here, the first resource allocation information may include information indicating multiple resource sets configured for transmission of the downlink control channel. For example, the first resource allocation information may include information indicating multiple resource sets configured for transmission of the control channel described in the fourth embodiment.

Thereafter, in step S1610, the UE may receive second resource allocation information associated with the resource region of the control channel from the BS. Here, the second resource allocation information may include information indicating whether at least one specific resource set belonging to multiple resource sets included in the first resource allocation information is available for transmission of the downlink data channel. For example, the second resource allocation information may include information indicating some resource sets which may be used for data transmission among the multiple resource sets described in the fourth embodiment.

In step S1615, the UE may identify a resource (i.e., a resource region) to which the downlink control channel and/or the downlink data channel are to be transmitted using the first resource allocation information and the second resource allocation information.

In step S1620, the UE may receive, from the BS, the downlink data channel through the at least one specific resource set when the at least one specific resource set is usable for the transmission of the downlink data channel.

Unlike this, if at least one specific resource set is not available for transmission of the downlink data channel, the UE may be configured to use the resource set for reception of the downlink control channel.

Information indicating whether the downlink data channel is available for transmission may be configured for each resource set or for each group consisting constituted by one or more resource sets. In addition, the information may be expressed in a bitmap format.

In this case, the at least one specific resource set may include at least one reserved resource set. When the at least one reserved resource set is activated, the resource set may be configured not to be used for transmission of the downlink data channel.

Further, the first resource allocation information may include information indicating at least one of a mapping structure, a transmission scheme, or a type of reference signal for each of the multiple resource sets. In addition, the first resource allocation information may include information indicating the number of BGs for each of the multiple resource sets.

In addition, when at least one specific resource set is allocated to the MBSFN subframe, transmission of the downlink control channel or a downlink data channel may be configured to be based on the DMRS.

General Apparatus to Which the Present Invention May Be Applied

FIG. 17 is a block diagram of a wireless communication device according to an embodiment of the present invention.

Referring to FIG. 17, the wireless communication system includes a base station 1710 and a plurality of terminals (or UEs) 1720 located within the region of coverage of the BS 2310.

The BS 1710 includes a processor 1711, a memory 1712, and a radio frequency (RF) unit 1713. The processor 1711 implements functions, processes and/or methods proposed in above-describes. Layers of radio interface protocols may be implemented by the processor 1711. The memory 1712 may be connected to the processor 1711 and stores various types of information for driving the processor 1711. The RF unit 1713 may be connected to the processor 1711 and transmits and/or receives a radio signal.

The UE 1720 includes a processor 1721, a memory 1722 and an RF unit 1723.

The processor 1721 implements the functions, processes and/or methods proposed in FIGS. 1 to 16. Layers of radio interface protocols may be implemented by the processor 1721. The memory 1722 may be connected to the processor 1721 and stores various types of information for driving the processor 1721. The RF unit 1723 may be connected to the processor 1721 and transmits and/or receives a radio signal.

The memory 1712, 1722 may be located inside or outside the processor 1711, 1721 and may be connected to the processor 1711, 1721 by various known means.

As an example, in a wireless communication system supporting a low latency service, the UE may include a radio frequency (RF) unit for transmitting and receiving a radio signal and a processor functionally connected with the RF unit in order to transmit and receive downlink (DL) data

Furthermore, the base station 1710 and/or the UE 1720 may have a single antenna or multiple antennas.

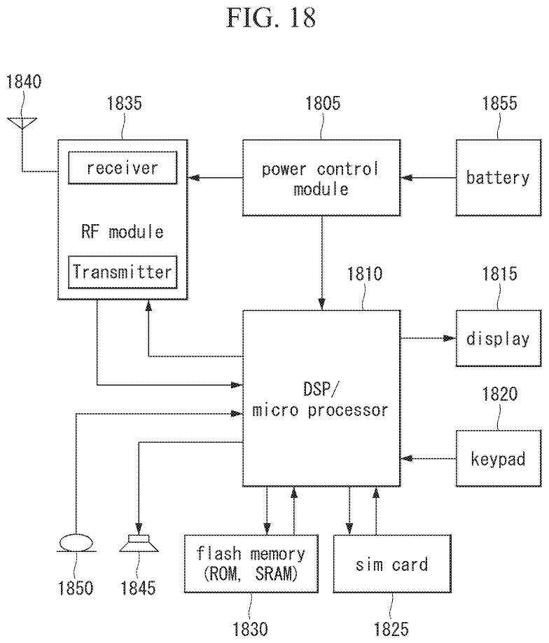

FIG. 18 illustrates a block diagram of a communication device according to an embodiment of the present invention.

In particular, FIG. 18 is a diagram more specifically illustrating the UE of FIG. 16 above.

Referring to FIG. 18, the UE may be configured to include a processor (or a digital signal processor (DSP) 1810, an RF module (or RF unit) 1835, a power management module 1805, an antenna 1840, a battery 1855, a display 1815, a keypad 1820, a memory 1830, a subscriber identification module (SIM) card 1825 (this component is optional), a speaker 1845, and a microphone 1850. The UE may also include a single antenna or multiple antennas.

The processor 1810 implements a function, a process, and/or a method which are proposed in FIGS. 1 to 16 above. Layers of a wireless interface protocol may be implemented by the processor 1810.

The memory 1830 is connected with the processor 1810 to store information related to an operation of the processor 1810. The memory 1830 may be positioned inside or outside the processor 1810 and connected with the processor 1810 by various well-known means.

A user inputs command information such as a telephone number or the like by, for example, pressing (or touching) a button on the keypad 1820 or by voice activation using the microphone 1850. The processor 1810 receives such command information and processes to perform appropriate functions including dialing a telephone number. Operational data may be extracted from the SIM card 1825 or the memory 1830. In addition, the processor 1810 may display command information or drive information on the display 1815 for the user to recognize and for convenience.

The RF module 1835 is connected with the processor 1810 to transmit and/or receive an RF signal. The processor 1810 transfers the command information to the RF module 1835 to initiate communication, for example, to transmit wireless signals constituting voice communication data. The RF module 1835 is constituted by a receiver and a transmitter for receiving and transmitting the wireless signals. The antenna 1840 functions to transmit and receive the wireless signals. Upon receiving the wireless signals, the RF module 1835 may transfer the signal for processing by the processor 1810 and convert the signal to a baseband. The processed signal may be converted into to audible or readable information output via the speaker 1845.

The aforementioned embodiments are achieved by combination of structural elements and features of the present invention in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

Embodiments according to the present invention may be implemented by various means, for example, hardware, firmware, software, or a combination thereof. In the case of hardware implementation, an embodiment of the present invention may be implemented by one or more application specific integrated circuits (ASICs), digital signal processors (DSPs), digital signal processing devices (DSPDs), programmable logic devices (PLDs) Field programmable gate arrays (FPGAs), a processor, a controller, a microcontroller, a microprocessor, or the like.

In the case of an implementation by firmware or software, an embodiment of the present invention may be implemented in the form of a module, a procedure, a function, or the like for performing the functions or operations described above. The software code can be stored in memory and driven by the processor. The memory is located inside or outside the processor and can exchange data with the processor by various means already known.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

Although a scheme of transmitting and receiving data in a wireless communication system of the present invention has been described with reference to an example applied to a 3GPP LTE/LTE-A system or a 5G system (New RAT system), the scheme may be applied to various wireless communication systems in addition to the 3GPP LTE/LTE-A system or 5G system.

1. A method for configuring a resource of a control channel in a wireless communication system supporting a short transmission time unit, the method performed by a user equipment(UE), comprising:
receiving, from a base station, first resource allocation information for allocating multiple resource sets configured for transmission of a downlink control channel;
receiving, from the base station, second resource allocation information indicating whether at least one specific resource set which belongs to the multiple resource sets is usable for transmission of a downlink data channel; and
receiving, from the base station, the downlink data channel through the at least one specific resource set when the at least one specific resource set is usable for the transmission of the downlink data channel.

2. The method of claim 1, wherein the at least one specific resource set includes at least one reserved resource set, and
wherein when the at least one reserved resource set is activated, the at least one reserved resource set is not used for the transmission of the downlink data channel.

3. The method of claim 1, wherein the first resource allocation information includes information indicating at least one of a mapping structure, a transmission scheme, or a type of reference signal for each of the multiple resource sets.

4. The method of claim 1, wherein the downlink control channel and the downlink data channel are configured according to a transmission time unit configured to a smaller number than 14 OFDM symbols.

5. The method of claim 1, wherein the first resource allocation information and the second resource allocation information are transmitted through higher layer signaling.

6. The method of claim 1, wherein the first resource allocation information is transmitted through the higher layer signaling, and
wherein the second resource allocation information is transmitted through downlink control information.

7. The method of claim 1, wherein when the at least one specific resource set is allocated to a Multicast-Broadcast Single Frequency Network (MBSFN) subframe, the transmission of the downlink control channel or the transmission of the downlink data channel is based on a Demodulation Reference Signal (DMRS).

8. The method of claim 1, wherein the first resource allocation information includes information for the number of blind decoding times for each of the multiple resource sets.

9. A User equipment (UE) configuring a resource of a control channel in a wireless communication system supporting a short transmission time unit, the UE comprising:
a Radio Frequency (RF) unit for transmitting and receiving a radio signal; and
a processor functionally connected to the RF unit,
wherein the processor is configured to;
receive, from a base station, first resource allocation information for allocating multiple resource sets configured for transmission of a downlink control channel,
receive, from the base station, second resource allocation information indicating whether at least one specific resource set which belongs to the multiple resource sets is usable for transmission of a downlink data channel, and
receive, from the base station, the downlink data channel through the at least one specific resource set when the at least one specific resource set is usable for the transmission of the downlink data channel.

10. A method for configuring a resource of a control channel in a wireless communication system supporting a short transmission time unit, the method performed by a base station, comprising:
transmitting, to a user equipment (UE), first resource allocation information for allocating multiple resource sets configured for transmission of a downlink control channel;
transmitting, to the UE, second resource allocation information indicating whether at least one specific resource set which belongs to the multiple resource sets is usable for transmission of a downlink data channel; and
transmitting, to the UE, the downlink data channel through the at least one specific resource set when the at least one specific resource set is usable for the transmission of the downlink data channel.
